(19) United States
(12) Patent Application Publication
(10) Pub. No.: US 2026/0065090 A1
(43) Pub. Date: Mar. 5, 2026

(54) INTERACTIVE PROCESSING METHOD AND DEVICE

(71) Applicant: Lenovo (Beijing) Limited, Beijing (CN)

(72) Inventor: Xuan WANG, Beijing (CN)

(21) Appl. No.: 19/307,838

(22) Filed: Aug. 22, 2025

(30) Foreign Application Priority Data
Aug. 28, 2024 (CN) 202411194576.6

(51) Int. Cl. G06N 5/022; H04L 67/306

(52) U.S. Cl. CPC G06N 5/022; H04L 67/306

(57) ABSTRACT

An interactive processing method includes identifying an obtained target input data to obtain a first user intent, processing the first user intent based on target reference information to obtain a second user intent and performing a response operation matching the second user intent, the target reference information corresponding to different target input data being different or the same.

### CROSS-REFERENCES TO RELATED APPLICATION

This application claims priority to Chinese Patent Application No. 202411194576.6 filed on Aug. 28, 2024, the entire content of which is incorporated herein by reference.

### FIELD OF TECHNOLOGY

The present disclosure relates to the field of data processing intelligence technology and, more specifically, to an interactive processing method and device.

### BACKGROUND

At present, a large language model (LLM) is commonly used to process user input data and obtain the corresponding instructions such as starting an application or pushing related messages.

However, the instruction execution results output by the large language model may not meet the user needs, resulting in poor user experience.

### SUMMARY

One embodiment of the present disclosure provides an interactive processing method. The method includes identifying an obtained target input data to obtain a first user intent, processing the first user intent based on target reference information to obtain a second user intent, and performing a response operation matching the second user intent. The target reference information corresponding to different target input data is different or the same.

Another embodiment of the present disclosure provides an electronic device. The electronic device includes one or more processors and one or more memories coupled to the one or more processors and storing a plurality of computer instructions that, when being executed, cause the one or more processors to perform: identifying an obtained target input data to obtain a first user intent, processing the first user intent based on target reference information to obtain a second user intent, and performing a response operation matching the second user intent. The target reference information corresponding to different target input data is different or the same.

Another embodiment of the present disclosure provides a non-transitory computer readable storage medium containing a plurality of computer instructions that, when being executed, cause at least one processor to perform: identifying an obtained target input data to obtain a first user intent, processing the first user intent based on target reference information to obtain a second user intent, and performing a response operation matching the second user intent. The target reference information corresponding to different target input data is different or the same.

### BRIEF DESCRIPTION OF THE DRAWINGS

To more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 is a flowchart of an interactive processing method according to some embodiments of the present disclosure.

FIG. 2 is an example diagram of an intelligent agent deployed locally in an electronic device.

FIG. 3 is a schematic structural diagram of an interactive processing device according to some embodiments of the present disclosure.

FIG. 4 is a schematic structural diagram of an electronic device according to some embodiments of the present disclosure.

FIG. 5 is a schematic diagram of a module design for a mobile phone according to some embodiments of the present disclosure.

FIG. 6 is an implementation flowchart for a mobile phone according to some embodiments of the present disclosure.

FIG. 7 is an example diagram of user interaction for a mobile phone according to some embodiments of the present disclosure.

FIG. 8 is an example diagram of identifying a user intent.

FIG. 9 is an example diagram of adjusting user intent after identifying the user intent applied to a mobile phone according to some embodiments of the present disclosure.

FIG. 10 is a schematic diagram of identifying user intent and performing operations through an intelligent agent.

FIG. 11 is an example diagram of adjusting user intent through local profile applied to a mobile phone according to some embodiments of the present disclosure.

FIG. 12 is a flowchart of an interaction between modules applied to a mobile phone according to some embodiments of the present disclosure.

FIG. 13 is a schematic diagram of a response operation of executing user intent through an intelligent agent applied to a mobile phone according to some embodiments of the present disclosure.

FIG. 14 is a schematic diagram of identifying user intent and performing operations through an intelligent agent applied to a mobile phone according to some embodiments of the present disclosure.

FIG. 15 is another schematic diagram of identifying user intent and performing operations through an intelligent agent applied to a mobile phone according to some embodiments of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

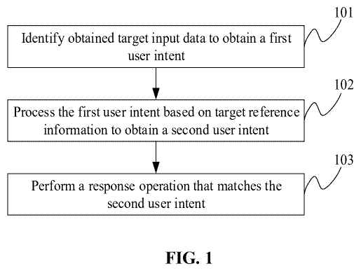

FIG. 1 is a flowchart of an interactive processing method according to some embodiments of the present disclosure. The method can be applied to electronic devices capable of data processing, such as mobile phones, tablet computers, computers or servers. The technical solution in this embodiment is mainly used to improve the user's interactive experience. The method will be described in detail below.
101, identifying obtained target input data to obtain a first user intent.

In some embodiments, the target input data can be any form of input data such as text input data, handwriting input data, gesture input data, voice input data, image input data, etc.

In some embodiments, the target input data may be obtained through an interactive interface. For example, a user can perform input operations in the form of text, handwriting, gestures, voice, images, etc. on the interactive interface to obtain target input data. For example, the interactive interface can be output to the user through a mobile phone. If the user enters the text “Tianjin” on the interactive interface, and the text “Tianjin” is the target input data.

In some embodiments, in the process at 101, an intent identification model may be used to perform intent identification to obtain the first user intent.

In some embodiments, the intent identification model can be a trained machine learning model that can process the target input data to output the identified first user intent.
102, processing the first user intent based on target reference information to obtain a second user intent.

In some embodiments, the target reference information may be related to target input data.

For example, the target reference information may be the user profile information, other input data, prompt words, current environment information or context information, etc.

More specifically, in this embodiment, the first user intent may be adjusted based on the target reference information to obtain the second user intent.

In some embodiments, compared with the first user intent, the second user intent may better represent the user needs of the user to which the target input data belongs. For example, if the number of words expressing the intent in the second user intent is greater than the number of words expressing the intent in the first user intent. Correspondingly, the second user intent is more accurate than the intent expressed by the first user intent.

For example, the first user intent is “introduce Tianjin”, and the first user intent is adjusted using the context information “study tours” to obtain the second user intent “introduce university information in Tianjin”, which can better reflect the user's operational intent.

At 103, performing a response operation that matches the second user intent.

For example, based on the second user intent “introduce university information in Tianjin”, information about universities related to Tianjin can be searched in the database or the Internet.

More specifically, in the process at 103, an execution strategy may be first determined based on the second user intent, and a corresponding response operation may be performed based on the determined execution strategy.

There can be many different execution strategies. For example, the execution strategy can be a strategy for executing a response operation immediately, or an execution strategy can be a strategy for executing a response operation based on a pre-set execution plan.

It should be noted that the target reference information corresponding to different target input data may be different or the same. In some embodiments, the corresponding target reference information may be obtained for the target input data. For example, for different types of target input data, or target input data in different scenarios, the corresponding target reference information can be obtained. In another example, for the target input data, corresponding reference information can be selected from multiple preset reference information as the target reference information. In another example, for the target input data, the corresponding scene information or environment information can be used as the target reference information.

Consistent with the present disclosure, after obtaining the first user intent by identifying the obtained target input data, the response operation matching the first user intent is not directly performed, but the first user intent is first processed based on the target reference information to obtain the second user intent. In this way, a response operation that matches the second user intent can be performed. By directly adjusting the obtained user intent based on the target reference information, a user intent that better meets the user's needs can be obtained, and then a response operation can be performed accordingly, which can better meet the user's needs, thereby improving the user's interactive experience.

In some embodiments, the target reference information may be obtained by first obtaining the content information and/or attribute information of the target input data, and then obtaining the target reference information based on the content information and/or attribute information.

It should be noted that the target reference information may be related or unrelated to the target input data. In some embodiments, the target reference information may be the default reference information, or the target reference information may be the reference information adapted to the current environment or interaction scenario. In this case, the target reference information is not related to the target input data. In other embodiments, the target reference information may be determined based on the target input data. In this case, the target reference information is related to the target input data.

In some embodiments, the content information may be the input content in the target input information. Based on this, the input content can be extracted from the target input data, and then the current interaction scenario can be determined based on the input content, and the target reference information can be obtained based on the interaction scenario. For example, the current interaction scenario is a scenario of discussing study tours, and the target reference information such as “university” or “school” is determined based on the interaction scenario. Alternatively, a method of obtaining the target reference information can be determined based on the interaction scenario, such as obtaining the target reference information from the preset reference information or obtaining the target reference information based on the scenario type.

The attribute information may be the type information, source information, input time, input location, amount of input data, etc. The type information can include text type, voice type, image type, URL type or code type, etc.; source information may be the source identifier such as the person or device to which the target input data belongs. Based on this, the target input data can be parsed to obtain at least one attribute information, and then the target reference information can be obtained based on the attribute information.

Based on the above description, in the embodiments of the present disclosure, obtaining the target reference information based on content information and/or attribute information can be realized by any one or more of the following methods.

In some embodiments, the interaction scenario represented by the content information can be determined, and then the target reference information that matches the interactive scenario can be obtained.

For example, the content information may be interactive content in a social media application, and correspondingly, the interactive scenario may be a social scenario between friends or family members through a social media application. Based on this, the target reference information matching the social scenario may be the context information of the interaction or the user profile information of both parties.

In another example, the content information may be the meeting content in a conference application, and correspondingly, the interaction scenario may be the work scenario between the conference application and the participants. Based on this, the target reference information matching the work scenario may also be work-related meeting minutes, related meeting plans, or meeting-related content, etc.

In another example, the content information may be the transaction communication content in a shopping application, and correspondingly, the interaction scenario may be the transaction scenario of communicating with the merchant. Based on this, the target reference information matching the transaction scenario may be information related to the transaction object or user profile information of the buyer.

In another example, the content information can control the control content in the application or control interface, and correspondingly, the interaction scenario may be a device control scenario used by users to implement device settings or control. Based on this, the target reference information matching the device control scenario may be the user's setting preference or the historical usage data of the device, etc.

In another example, the content information may be used to call the calling content or functional content of the function provided by the device, and correspondingly, the interaction scenario may be a scenario in which the user calling the functional service that the device can provide. Based on this, the target reference information matching the scenario can be the user historical usage data or device configuration update data, etc.

In some embodiments, the interactive object in the content information may be determined, and then the target reference information matching the interactive object may be obtained.

In some embodiments, the interaction objects can be people in social interaction, participants in conference interaction, transaction objects in transaction communication, controlled objects (such as devices, applications, etc.), required functional service objects, etc. Correspondingly, the target reference information matched with the interaction object may be the user profile information of the user or the user profile information of the two parties in the interaction, or the group profile information of the group to which one or both parties in the interaction belong; it may be the meeting minutes related to the participants, the related meeting plan, or the meeting-related content, etc.; it may be information related to the transaction object or the buyer's user profile information; or the accused historical data of the accused, etc.

In some embodiments, the data type of the target input data represented by the attribute information may be determined, and then the target reference information matching the data type may be obtained.

In some embodiments, the data types of the target input data may be the text type, voice type, image type, URL link type, code type, etc.

It should be noted that different data types can match different target reference information. For example, the text type can match the target reference information of the processing options used to process the text. In another example, the text type can match the style or color that makes the text more in line with the user's habits or preferences, or modify the tone and other related target reference information. In another example, the image type can match additional attribute information that matches the image theme or style as the target reference information.

In some embodiments, the source information of the target input data represented by the attribute information may be determined, and then the target reference information matching the source information may be determined.

The source information may be the user (person), device, etc. from which the target input data comes from. Based on this, if the source information represents that the target input data comes from a person, then the target reference information of the user profile information or historical usage data related to the person can be obtained based on the source information. Alternatively, if the source information represents that the target input data comes from a device, then the configuration data or log information of the device can be obtained based on the source information as the target reference information.

In some embodiments, the input position of the target input data represented by the attribute information may be determined, and then the target reference information matching the input position may be obtained.

The input position may be the environment where the electronic device is located when the target input data is input, such as indoors or outdoors, home or work area, city, country, etc. Correspondingly, the target reference information that matches the input position may be the historical related data that matches the current environment or data that can reflect the local characteristics and style.

The input position may also be an input box for an application being operated on the electronic device, that is, the input position may be the position of the input box. Correspondingly, the target reference information matched with the input position may be information related to the application, for example, specific information related to the application that matches with the target input data.

In some embodiments, the data size of the target input data represented by the attribute information may be determined, and then the target reference information matching the data size may be obtained.

The data size may be the data size of any parameter related to the target input data. For example, the data size can be the number of keywords in the target input data, or the data size can be the resolution of the image in the target input data.

In some embodiments, user profile information associated with content information and/or attribute information may be obtained, and then the user profile information may be used as target reference information.

More specifically, the content information and/or attribute information may be processed by keyword extraction or analysis to obtain the relevant user profile information, such as “user preference for gourmet food or preference for dieting”, and then the user profile information may be used as target reference information.

In some embodiments, long-term memory associated with the content information and/or attribute information may be acquired and used as the target reference information.

The long-term memory may be read historical information from the user or device where the target input data comes from. For example, the information that users process most frequently through their devices in the past year is food. Correspondingly, food is the user's long-term memory, and the corresponding target reference information can be “food”.

In some embodiments, short-term memory associated with content information and/or attribute information may be acquired and used as target reference information.

Short-term memory may be read from the historical information of the user or device from which the target input data comes. For example, the user is currently chatting with friends about “school” through a social application on the device. Correspondingly, the school category is the user's short-term memory, and the corresponding target reference information can be “university”.

In some embodiments, the comment for the first user's intent may be obtained, and then the corresponding target reference information may be obtained based on the comment.

The comment for the first user's intent may be feedback information of the user on the first user's intent, for example, the feedback information may be feedback information that approves the first user's intent or feedback information that disapproves the first user's intent. In another example, the feedback information may be feedback information of further suggestions proposed by the user for the first user intent. In another example, the feedback information may be feedback information of adjustment or correction proposed by the user for the first user intent. In some embodiments, the user's feedback operation may be obtained through the interactive interface, and the comment may be obtained.

For example, the first user intent may be “introduce Tianjin”, and the user may comment on the first user intent through the interactive interface, “this is not right” or “I want to see what delicious food there is”. Based on this, for the comment of “This is not right”, the target reference information of changing to other regions such as “Beijing” is obtained, and the first user intent can be adjusted to obtain the second user intent such as “introduce Beijing”. For the comment of “I want to see what delicious food there is”, the target reference information such as “food” is obtained, and the first user intent can be adjusted based on this to obtain the second user intent such as “introduce Tianjin's food”

Based on the above example, obtaining the corresponding target reference information based on the comment can be realized in any one or more of the following methods.

In some embodiments, when the comment includes the first feedback information of the target user on the first user intent, the preset reference information matching the first user intent may be used as the target reference information.

The first feedback information may be feedback information of a positive comment made by the target user in response to the first user intent. For example, the feedback information of approving the recommended content represented by the first user intent. Based on this, the preset reference information matching the first user intent can be used as the target reference information.

In some embodiments, when the comment includes the second feedback information of the target user on the first user intent, the second feedback information may be directly used as the target reference information, or the target reference information may be generated based on the second feedback information.

The second feedback information may be the feedback information of a positive comment made by the target user in response to the first user intent, for example, feedback information of not approving the recommended content represented by the first user intent. Based on this, the second feedback information can be used as the target reference information, for example, “incorrect” can be used as the target reference information; or, new target reference information can be generated based on the second feedback information, for example, the target reference information of “change city” can be generated based on the feedback information of “incorrect”. Correspondingly, the first user intent may be adjusted based on the target reference information to obtain the second user intent. For example, the first user intent of “introduce Tianjin” can be adjusted to the second user intent of “introduce Beijing” based on “changing cities”.

In some embodiments, when the comment includes supplementary information of the target user on the first user intent, the target reference information may be generated based on the supplementary information.

The supplementary information may be a supplementary limitation or supplementary content of the target user with respect to the first user intent. For example, the supplementary information may be similar content “Also Beijing” added to “introduce Tianjin” or information “Nankai District” added to limit the scene or scope. Correspondingly, the target reference information “add Beijing City” or “further introduce Nankai District” can be generated. In this way, the first user intent can be adjusted based on the target reference information to obtain the second user intent. For example, the first user intent of “introduce Tianjin” can be adjusted to the second user intent of “introduce Nankai District of Tianjin” based on “further introduce Nankai District”.

Based on the above implementations, in the process at 102, processing the first user intent based on the target reference information may be realized in one of the following methods.

In some embodiments, an attribute label corresponding to the target reference information or a prompt word corresponding to the target reference information may be added to the first user intent to obtain the second user intent.

The target reference information may be obtained by the implementation method described above. The attribute label may be a behavior attribute or a description attribute generated based on the target reference information. The behavior attribute may be control type or execution type action attribute, such as open, close, uninstall, install, increase, decrease, etc. The description attribute may be a descriptive attribute that make it easier for the model to understand or execute, for example, the description attribute may be polishing, expansion, limitation, and translation. The prompt word may be a prompt content that further expands the first user intent, for example, expanding a word into a sentence, or adding an execution instruction of a keyword. More specifically, the prompt word can be a descriptive word extracted from the target reference information. Based on this, the corresponding attribute labels or prompt words may be added to the first user intent based on the attribute labels or prompt words corresponding to the target reference information such that a new user intent, namely the second user intent, can be obtained.

In some embodiments, the target reference information may be used to generate or replace the first user intent to obtain the second user intent.

In some embodiments, the target reference information and the first user intent can be input into an artificial intelligence generated content (AIGC) model, and the AIGC model can perform the generation processing to obtain the second user intent output by the AIGC model.

For example, the target reference information “add Beijing City” and the first user intent of “introduce Tianjin” are input into the AIGC model, and the AIGC model outputs the second user intent of “introduce Tianjin and Beijing”.

Alternatively, the corresponding data in the first user intent may be replaced with the relevant data in the target reference information to obtain the second user intent. For example, the target user is used to turn on the eye protection mode when using electronic devices. When the electronic device identifies that the first user intent represented by the “display mode” input by the user is “changing the current display mode to bright mode”, the “bright mode” can be replaced based on the user habits or preferences provided by the user profile information to obtain the second user intent of “changing the current display mode to eye protection mode”.

In some embodiments, the first user intent may be processed based on a processing strategy corresponding to the type and/or source of the target reference information to obtain the second user intent.

The type of target reference information may be the type of user profile, the type of long-term memory and short-term memory, the type of comment or feedback information on the first user intent, the type of text data, the type of image data, etc. The source of the target reference information can be understood as a method of obtaining the target reference information, such as the various methods of obtaining the target reference information described above.

Based on this, the processing strategy corresponding to the type and/or source of the target reference information may include an identification processing strategy for generating or understanding the target reference information and the first user intent using different models.

For example, the processing strategy may be a processing strategy for editing the first user intent using the target reference information. The processing strategy may be implemented based on the operation on the interactive interface. For example, the target reference information and the first user intent may be output on an interactive interface and provided to the target user, and the target user may edit the first user intent on the interactive interface based on the target reference information to obtain the second user intent.

In another example, the processing strategy may be a processing strategy for adjusting the weight, priority, or order of the intent keywords in the first user intent using the target reference information. The processing strategy may be executed in the background or implemented based on the configuration operation on the interactive interface. For example, the intent keyword in the first user intent may be directly replaced based on the keyword in the target reference information to obtain the second user intent. Alternatively, the target reference information and the first user intent may be output on the interactive interface and provided to the target user. The target user may adjust the order of the intent keywords in the first user intent on the interactive interface based on the keywords in the target reference information to obtain the second user intent.

In another example, the processing strategy may be a processing strategy for replacing the first user intent with the target reference information. For example, in a scenario where the first user intent represents the target user performing a security or privacy processing, the target reference information may replace the first user intent to obtain the second user intent.

More specifically, processing the first user intent based on the processing strategy corresponding to the type and/or source of the target reference information may be realized by at least one of the following implementation methods

In some embodiments, when the target reference information is user profile information of the target user, the first user intent may be generated or updated based on the user profile information to obtain the second user intent.

For example, the target reference information is user profile information associated with the content information and/or attribute information of the target input data such as the profile information of “user prefers gourmet food”. In this way, based on the user profile information, the intent keywords in the first user intent can be regenerated or replaced to obtain the second user intent. For example, for the first user intent of “introduce Tianjin”, “Tianjin” can be replaced to obtain the second user intent of “introduce delicious food”.

In some embodiments, when the target reference information only includes long-term memory, the first user intent may be adjusted or edited based on the long-term memory to obtain the second user intent.

For example, the target reference information only includes the long-term memory “food category”, based on which the first user intent can be edited based on the long-term memory to obtain the second user intent of “introduce Tianjin's food”.

In some embodiments, when the target reference information includes short-term memory and long-term memory, the first user intent may be updated based on the short-term memory, or, when the first user intent cannot be updated by using the short-term memory, the first user intent may be updated by using the long-term memory to obtain the second user intent.

For example, the target reference information includes the long-term memory “food” and the short-term memory “university”. Based on this, the first user intent “introduce Tianjin” can be updated with “university” first to obtain the second user intent of “introduce universities in Tianjin”. If short-term memory cannot be used to update the first user intent, such as when short-term memory cannot be identified, the long-term memory “food category” may be used to update the first user intent of “introduce Tianjin” to obtain the second user intent of “introduce Tianjin's food”.

In some embodiments, when the target reference information is a comment for the first user intent, the first user intent may be replaced based on the comment, or the comment and the first user intent may be further understood to obtain the second user intent.

For example, the comment may be “not as good as Beijing”. Based on this, the comment can be used to replace the first user intent of “introduce Tianjin” with the intent keyword to obtain the second user intent of “introduce Beijing”. In another example, the comment may be “I want to see what delicious food there is”. Based on this, the comment and the first user intent of “introduce Tianjin” can be processed again using the model to obtain a new second user intent of “introduce Tianjin's food”.

In some embodiments, when the target reference information comes from a target application, the first user intent may be updated based on the application information of the target application to obtain the second user intent.

The updating process may be at least one of replacement, production, adjustment, editing, and the like. For example, the first application intent of “uninstall video A” can be updated based on the target application “video B” to obtain the second user intent of “uninstall video B”.

In some embodiments, when the target reference information comes from the target space environment, the first user intent may be modeled based on the environmental parameters of the target space environment to obtain the second user intent.

For example, the target space environment refers to a stadium, indoor, city, country and other space environments. Based on this, the first user intent of “introduce this place” can be modeled based on the environmental parameters of the target space environment, such as “C Shopping Mall in Beijing”, to obtain the second user intent of “introducing the food in C Shopping Mall in Beijing”.

Based on this, the process at 103 can be implemented by at least one of the following implementation methods when performing the response operation matching the second user intent.

In some embodiments, a corresponding execution strategy may be determined based on the second user intent to call a corresponding application tool to perform a target response operation based on the execution strategy.

The execution strategy can be an execution or a delayed execution. The application tool can be a calendar, email, large model, computer manager or other device assistants.

For example, a computer manager can be used to immediately execute the target response operation of “uninstalling video B” intended by the second user.

In some embodiments, a corresponding execution strategy may be determined based on the second user intent to call the corresponding intelligent agent to perform the target response operation based on the execution strategy.

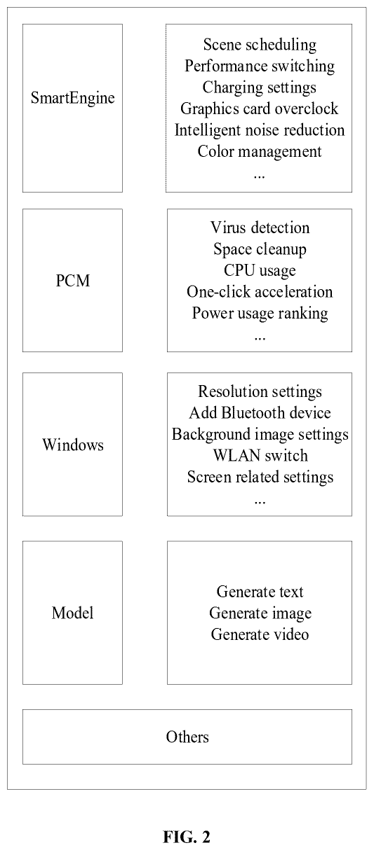

The intelligent electronic device can be a deployed locally intelligent agent. As shown in FIG. 2, the laptop can be deployed with intelligent agents such as a smart engine, a phase change memory (PCM) intelligent agent, a Windows intelligent agent, a model, etc. The smart engine can realize scene scheduling, performance switching, charging settings, graphics card overclocking, intelligent noise reduction, color management and other functions. The PCM intelligent agent can realize virus detection, space cleaning, one-key acceleration, CPU usage, power consumption ranking and other functions. The Windows intelligent agent can realize functions such as resolution setting, adding Bluetooth devices, wireless local area network (WLAN) switching, background image setting, screen related settings, etc. The model can realize functions such as generating text, generating pictures and generating videos.

For example, based on the immediate execution strategy of the second user intent of “uninstalling video B”, the PCM intelligent agent can be called to perform the target response operation, that is, uninstalling video B.

In some embodiments, a corresponding execution strategy may be determined based on the second user intent and the operating state information of the electronic device to call a corresponding application tool or intelligent agent to perform a target response operation based on the execution strategy.

The operating state information of the electronic device may include the usage state of the application tool or intelligent agent and the performance state of the device. For example, the usage state of an application tool or an intelligent agent may be whether it is occupied. In this embodiment, the corresponding execution strategy can be determined based on this. For example, if the application tool or the intelligent agent is currently occupied or the performance state of the electronic device indicates that the electronic device is busy, the execution strategy may be to delay execution until the application tool or the intelligent agent enters an idle state or the electronic device is idle.

Based on the above implementation, this embodiment may also include at least one of the following processing.

In some embodiments, the second user intent may be updated based on the obtained third feedback information regarding the execution result of the response operation.

The third feedback information may be feedback information of the target user on the execution result after the response operation matching the second user intent is executed. For example, the feedback information on whether you agree or disagree with the execution result. Based on this, the second user intent can be updated based on the third feedback information, and then the response operation matching the newly obtained second user intent can be re-executed.

For example, after executing the response operation matching “introduce Tianjin's Food”, that is, outputting information about Tianjin's food, the target user's feedback on the information about Tianjin's food is obtained, such as the feedback information that agrees with the execution result. Based on the feedback information, “introduce Tianjin's food” is updated to obtain a new second user intent of “output more food information”, and then the response operation of “output more food information” can be re-executed.

In some embodiments, the second user intent may be updated based on the input operation of the interactive interface acting on the target intelligent agent.

The target intelligent agent may be an artificial intelligence (AI) agent integrated in an electronic device. The target intelligent agent can provide an interactive interface, which prompts the target user to perform input operations on the second user intent such that the target user can perform input operations on the interactive interface of the target intelligent agent, and the second user intent can be updated on the electronic device based on the input operation.

The input operation may be a configuration operation performed by the target user on the interactive interface for the second user intent. For example, the target user configures “introduce Tianjin's delicacies” on the intelligent agent's interactive interface, and can obtain a new second user intent of “introduce Tianjin's fried dough twist and steamed buns”, based on which the response operation of “introduce Tianjin's fried dough twist and steamed buns” can be re-executed.

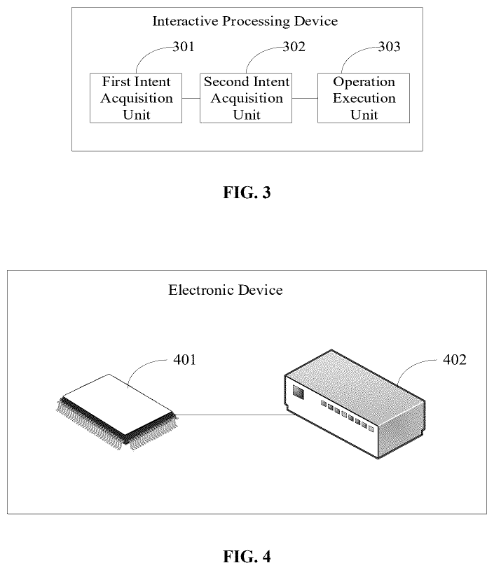

FIG. 3 is a schematic structural diagram of an interactive processing device according to some embodiments of the present disclosure. The device can be configured in an electronic device capable of data processing, such as a mobile phone, a tablet computer, a computer or a server, etc. The technical solution in this embodiment is used to improve the user's interactive experience.

As shown in FIG. 3, the interactive processing device includes a first intent acquisition unit 301, a second intent acquisition unit 302 and an operation execution unit 303.

In some embodiments, the first intent acquisition unit 301 may be configured to identify the obtained target input data to obtain a first user intent.

In some embodiments, the second intent acquisition unit 302 may be configured to process the first user intent based on target reference information to obtain a second user intent.

In some embodiments, the operation execution unit 303 may be configured to perform a response operation matching the second user intent.

In some embodiments, the target reference information corresponding to different target input data may be different or the same.

Consistent with the present disclosure, after obtaining the first user intent by identifying the obtained target input data, the response operation matching the first user intent is not directly performed, but the first user intent is first processed based on the target reference information to obtain the second user intent. In this way, a response operation that matches the second user intent can be performed. By directly adjusting the obtained user intent based on the target reference information, a user intent that better meets the user's needs can be obtained, and then a response operation can be performed accordingly, which can better meet the user's needs, thereby improving the user's interactive experience.

In some embodiments, the second intent acquisition unit 302 may be further configured to obtain content information and/or attribute information of the target input data, and obtain the target reference information based on the content information and/or the attribute information, the target reference information being related to or unrelated to the target input data, and obtain comment for the first user intent, and obtain the corresponding target reference information based on the comment.

In some embodiments, the second intent acquisition unit 302 obtaining the target reference information based on the content information and/or the attribute information may include one or more of determining the interaction scenario represented by the content information, and obtaining the target reference information matching the interaction scenario; determining the interactive object in the content information, and obtaining the target reference information matching the interactive object; determining the data type of the target input data represented by the attribute information, and obtaining the target reference information matching the data type; determining the source information of the target input data represented by the attribute information, and obtaining the target reference information matching the source information; determining the input position of the target input data represented by the attribute information, and obtaining the target reference information matching the input position; determining the data size of the target input data represented by the attribute information, and obtaining the target reference information matching the data size.

In some embodiments, the second intent acquisition unit 302 obtaining the target reference information based on the content information and/or the attribute information may include one or more of obtaining the user profile information associated with the content information and/or the attribute information, and using the user profile information as the target reference information; obtaining the long-term memory associated with the content information and/or the attribute information, and using the long-term memory as the target reference information; obtaining the short-term memory associated with the content information and/or the attribute information, and using the short-term memory as the target reference information.

In some embodiments, the second intent acquisition unit 302 obtaining the corresponding target reference information based on the comment may include one or more of using the preset reference information matching the first user intent as the target reference information when the comment includes first feedback information from the target user on the first user intent; directly using the second feedback information as the target reference information, or generating the target reference information based on the second feedback information when the comment includes the second feedback information of the target user on the first user intent; generating the target reference information based on the supplementary information when the comment includes the supplementary information of the target user to the first user intent.

In some embodiments, the second intent acquisition unit 302 processing the first user intent based on the target reference information may include one or more of adding the attribute label corresponding to the target reference information or the prompt word corresponding to the target reference information to the first user intent to obtain the second user intent; using the target reference information to generate or replace the first user intent to obtain the second user intent; processing the first user intent based on a processing strategy corresponding to the type and/or source of the target reference information to obtain the second user intent.

In some embodiments, the second intent obtaining unit 302 processing the first user intent with a corresponding processing strategy based on the type and/or source of the target reference information may include one or more of generating or updating the first user intent based on the user profile information to obtain the second user intent when the target reference information is the user profile information of the target user; adjusting or editing the first user intent based on the long-term memory to obtain the second user intent when the target reference information consists only the long-term memory; updating the first user intent based on the short-term memory to obtain the second user intent when the target reference information includes the short-term memory and the long-term memory, or updating the first user intent using the long-term memory to obtain the second user intent when the first user intent cannot be updated using the short-term memory; replacing the first user intent based on the comment or processing the comment and the first user intent again to obtain the second user intent when the target reference information is comment for the first user intent; updating the first user intent based on the application information of the target application to obtain the second user intent when the target reference information comes from a target application; performing model generation processing on the first user intent based on the environmental parameters of the target space environment to obtain the second user intent when the target reference information comes from the target space environment.

In some embodiments, the operation execution unit 303 executing the response operation matching the second user intent may include one or more of determining a corresponding execution strategy based on the second user intent, and calling a corresponding application tool to perform a target response operation based on the execution strategy; determining a corresponding execution strategy based on the second user intent, and calling a corresponding intelligent agent to perform a target response operation based on the execution strategy; determining a corresponding execution strategy based on the second user intent and the operation state information of the electronic device, and calling a corresponding application tool or intelligent agent to perform a target response operation based on the execution strategy.

In some embodiments, the second intent acquisition unit 302 may be further configured to update the second user intent based on the third feedback information obtained for the execution result of the response operation; update the second user intent based on the input operation acting on the interactive interface of the target intelligent agent.

It should be noted that, for the specific implementation method of each unit in this embodiment, reference can be made to the corresponding content in the foregoing embodiments and will not be described in detail here.

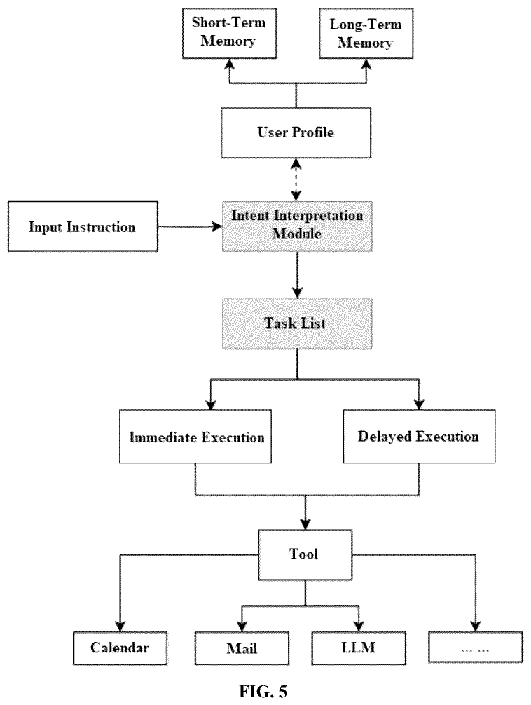

FIG. 4 is a schematic structural diagram of the electronic device according to some embodiments of the present disclosure. The electronic device may be a mobile phone, a tablet computer, or a computer.

As shown in FIG. 4, the electronic device includes a memory 401 and a processor 402.

In some embodiments, the memory 401 may be configured to store computer programs and data generated by the operation of the computer programs.

In some embodiments, the processor 402 may be configured to execute the computer programs to implement the interactive processing method described in any of the foregoing embodiments.

An embodiment of the present disclosure further provides a computer storage medium on which a computer program/instruction is stored. When the computer program/instruction is executed by a processor, the interactive processing method described in any of the foregoing embodiments can be implemented.

An embodiment of the present disclosure also provides a computer program product, including a computer program/instruction, which, when executed by a processor, implements the interactive processing method described in any of the foregoing embodiments.

The technical solutions of the present disclosure will be described below by taking a mobile phone as an example.

After the user inputs a prompt such as text or an image, the system can understand the intent and proactively push relevant service content based on the user's profile or habits to make an artificial intelligence personal computer (AIPC) that understands the user better.

In related art, the training corpus is generated bonded with the intent through pre-training. This method is relatively fixed and not flexible enough. For example, the intent mapped to “A video” is “open A video”. After the user inputs, the intent is understood and returned to “open A video” and its work is completed. The subsequent additional operation of “if not installed, prompt the user to install or pop up the installation interface” is only the behavior of the local software control logic based on the result of the intent feedback.

In view of this, the technical solutions provided in the present disclosure requires the support of the following contents.
1. Data collection and analysis: First, user data needs to be collected. The user data may include user behavior data, preference data, historical data, and the types and contents of files that are generally processed. By analyzing and mining this data, the user's interests and needs can be understood, and a personal local profile of the user can be generated.
2. Recommendation algorithm: The execution of user commands can be determined based on the long-term and short-term memory information of the user profile and the intent category.

FIG. 5 is a schematic diagram of a module design for a mobile phone according to some embodiments of the present disclosure. In this embodiment, after the user inputs the command, the task list corresponding to the user's intent can be obtained through the intent interpretation module based on the user profile information constructed by the short-term memory and the long-term memory. Each user intent in the task list may be executed immediately or delayed. In this way, based on the execution strategy, the corresponding tools such as calendar, email, big model, etc. can be used to perform the response operation that matches the user intent.

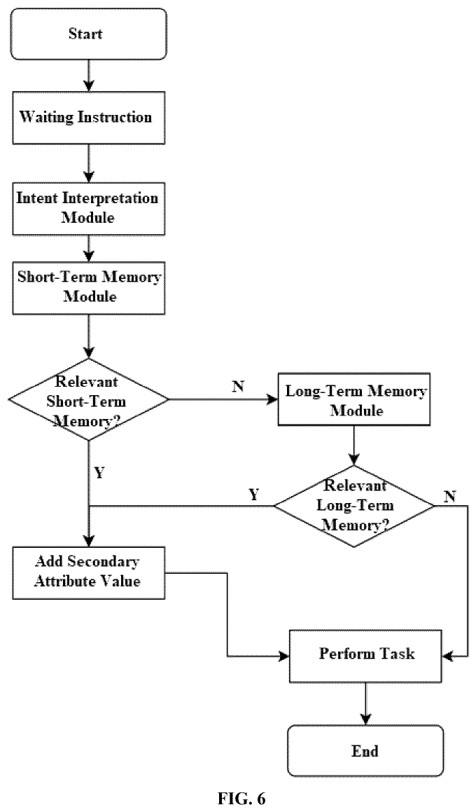

Combined with the implementation process shown in FIG. 6, the implementation process of the present disclosure will be described below.

First, after waiting for the user's instruction, the intent interpretation module is used to perform intent identification on the input data corresponding to the user's instruction to obtain the first user intent. Then the short-term memory module can be used to find out whether there is relevant short-term memory. If the relevant short-term memory is available, then a secondary attribute value can be added to the first user intent based on the short-term memory such that the obtained second user intent can be added to the task list. If the relevant short-term memory is not available, then the long-term memory module can be used to find out whether there is relevant long-term memory. If the relevant long-term memory is available, then the secondary attribute value can be added to the first user intent based on the long-term memory such that the obtained second user intent can be added to the task list. If the relevant long-term memory is not available, then the tasks can be performed based on the task list.

This embodiment has the advantages of making the purpose of user prompt more personal, and making the software more intelligent by combining the user profile, multiple intents or user context data.

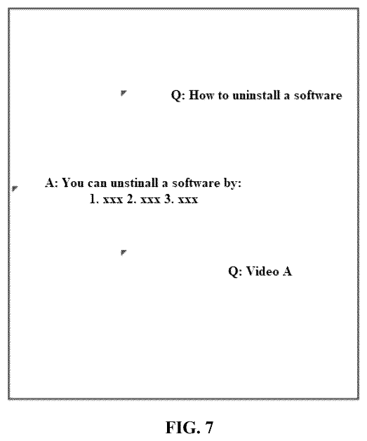

For example, based on the intent interpretation in short-term memory (e.g., conversation context), take the prompt “Video A” as an example. As shown in FIG. 7, the user's first question is “how to uninstall the software” and the user's second question is “video A”.

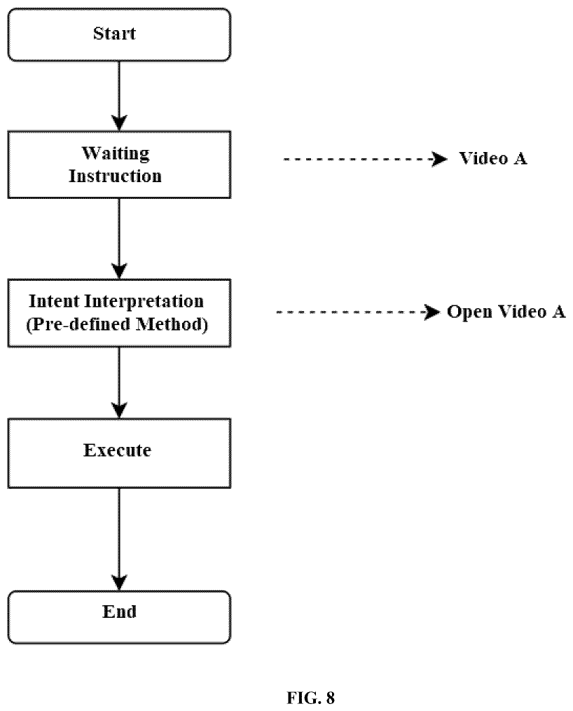

Based on the current implementation method, as shown in FIG. 8, after waiting for the instruction of “video A”, the user intent of “open Video A” can be interpreted based on the intent of the predefined method, and then the response operation can be performed, namely, open video A.

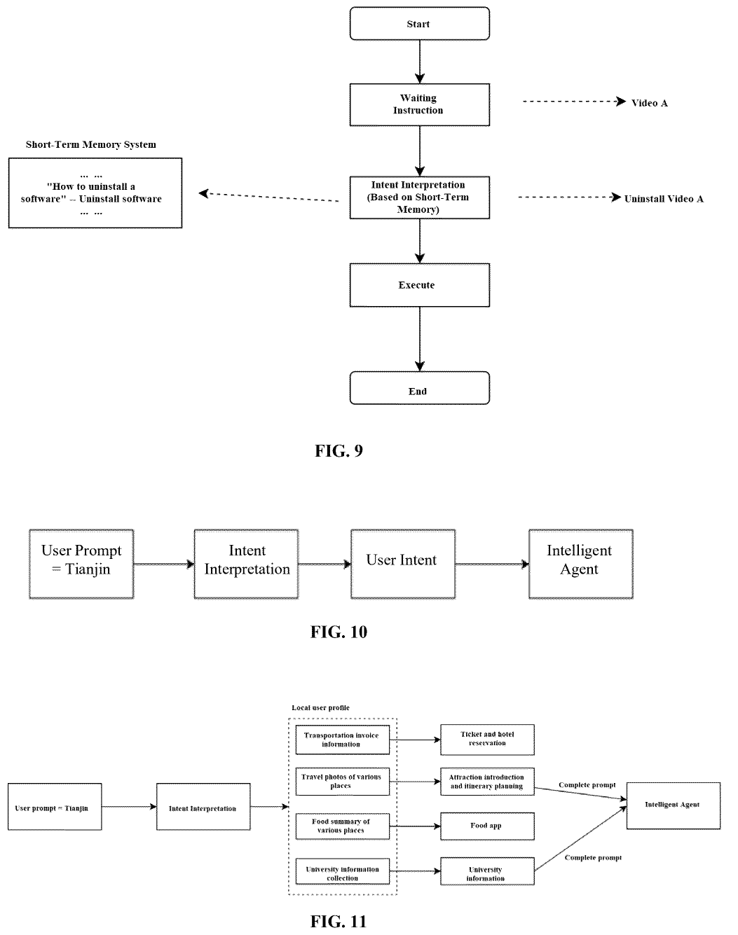

Based on the implementation method in the embodiment shown in FIG. 9, after waiting for the instruction of “video A”, based on the target reference information “uninstall software” corresponding to “how to uninstall software” in the short-term memory module, the intent interpretation module can be used to obtain the user intent of “uninstall video A” based on short-term memory, and then execute the response operation, that is, open Video A.

For example, when the user prompt is “Tianjin”, the original implementation process is shown in FIG. 10. The corresponding user intent is identified through intent interpretation, and then the model and other intelligent agents can perform the response operations that match the user intent. The implementation process in this embodiment is shown in FIG. 11. The corresponding user intent is identified through intent interpretation, and then the target reference information is obtained in combination with the user's local profile, that is, the prompt after completion. The user intent is then adjusted accordingly, and the response operation that matches the user intent is executed through the model and other intelligent agents.

For example, the local user profile may be the profile information of bus tickets and hotel reservation software obtained through transportation invoice information; information such as introductions to scenic spots and itinerary planning obtained through travel photos from various places; the profile information of food software obtained through food collection from various places; the profile information of university information obtained through university information collection, etc.

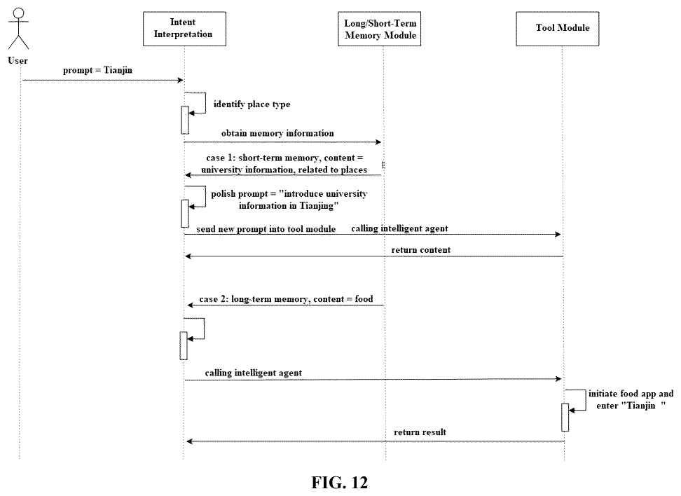

Take the user prompt as “Tianjin” as an example, the interaction process between modules may be as shown in FIG. 12.

First, the intent interpretation module identifies the place type of “Tianjin”; then, the intent interpretation module requests the long/short memory module to obtain memory information.

In some cases, if the short-term memory module feeds back short-term memory that the content is university information, which is related to a place, then the intent interpretation module will polish the user intent corresponding to the prompt, obtain the new user intent “introduce university information in Tianjin”, and then pass the user intent corresponding to the new prompt to the tool module. Subsequently, the tool module calls the corresponding application tool or the intelligent agent to perform the response operation.

In other cases, if the short-term memory module does not feedback short-term memory, and the long-term memory module feedbacks long-term memory that the content is food, then the intent interpretation module defines a food tool, and inputs the parameter “Tianjin”. In this way, the new user intent “Tianjin” and “food tool” are obtained and sent to the new prompt into the tool module. The tool module calls the corresponding application tool or intelligent agent to perform the response operation, such as starting the food software and inputting “Tianjin” into the food software to produce key output of food recommendation information related to “Tianjin”.

In addition, in some embodiments, the local intelligent agent of the electronic device can be used when executing the response operation matching the user intent. The process is described in detail below.

Consistent with the present disclosure, through the intent interpretation module, the user's intent is identified, and combined with the local intelligent agent set of the electronic device, one or more intelligent agent combination calls are provided to the user to provide a more convenient and comprehensive solution for the user. The core of the technical solution of this embodiment mainly includes the training of the intent interpretation model in the intent interpretation module, the relationship mapping between the intelligent agent and the intent interpretation model, and the registration and calling of the intelligent agent's capabilities, which will be described in detail below.

### 1. Model Training of the Intent Interpretation Model.

Model training can provide corresponding words and response slots based on the capabilities of the intelligent agent. Take the smart engine's scene scheduling as an example.

TABLE 1
Slot and speech

| Intent | Slot | Speech |
|---|---|---|
| Scene setting | Meeting scene | 1. Help me set up a meeting scene |
| scheduling | | 2. I'm about to start a meeting |
| | | 3. Switch meeting scene |
| | | . . . |
| | Game scene | 1. Help me set up a game scene |
| | | 2. I'm about to plan a game |
| | | 3. Switch game scene |
| | | . . . |

Based on Table 1, the intent interpretation model can be generated using the model generalization content. When the user's prompt is similar to the speech content described above, the intent interpretation model can lock the slot information of its data map.

### 2. Relationship Mapping Between the Intelligent Agent and the Intent Interpretation Model.

Still taking the above case as an example, after the intent interpretation training is completed, it is necessary to establish a mapping relationship with the intelligent agent. In this design, the mapping is labeled in the form of a cmd plus param, as shown in Table 2.

TABLE 2
CMD and Param

| Intent | Slot | CMD | Param |
|---|---|---|---|
| Scene setting | Meeting scene | se.scene.status.set | Meeting |
| scheduling | Game scene | | Game |

At this point, when the user prompt hits the above intent, the specific cmd and param can be located. For example, if the user enters “I'm in a meeting”, the return of se.scene.status.set combined with meeting will be obtained.

### 3. Intelligent Agent Capability Registration.

Due to the differences in the capabilities of each device and the installation of related functional software, each device behaves differently. When the technical solution in this embodiment is initiated, the support state of each intelligent agent on the device will be detected. In some embodiments, the support state is also used in the subsequent intelligent agent call and user information feedback logic.

TABLE 3
Mapping relationship

| Intent | Slot | CMD | Param | Precondition |
|---|---|---|---|---|
| Scene | Meeting | se.scene.status.set | Meeting | se.scene.ability_meeting |
| setting | scene | | | |
| scheduling | Game | | Game | se.scene.ability_game |
| | scene | | | |

Whether this capability is supported can be determined based on the “precondition” field. For example, if the current device only supports the meeting scene but not the game scene, then the technical solution of this embodiment will only return se.scene.ability_meeting when detecting the SE intelligent agent, indicating that it has the ability of the meeting scene.

### 4. Calling of Intelligent Agent.

After receiving se.scene.status.set combined with “meeting”, the technical solution in this embodiment needs to pass this information to the smart engine SDK and call the software's own function to perform the setting.

### 5. Call Feedback.

After calling, based on the setting result of SE, the corresponding words will be displayed to the user.

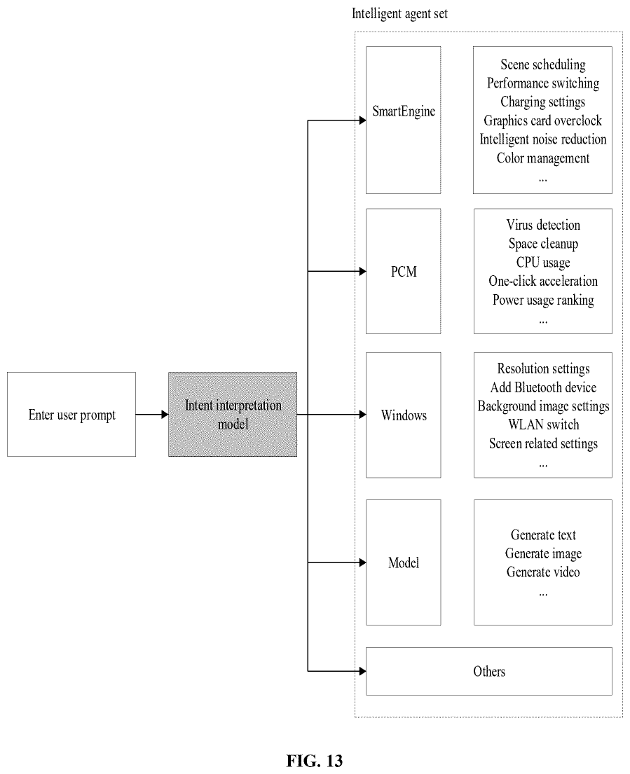

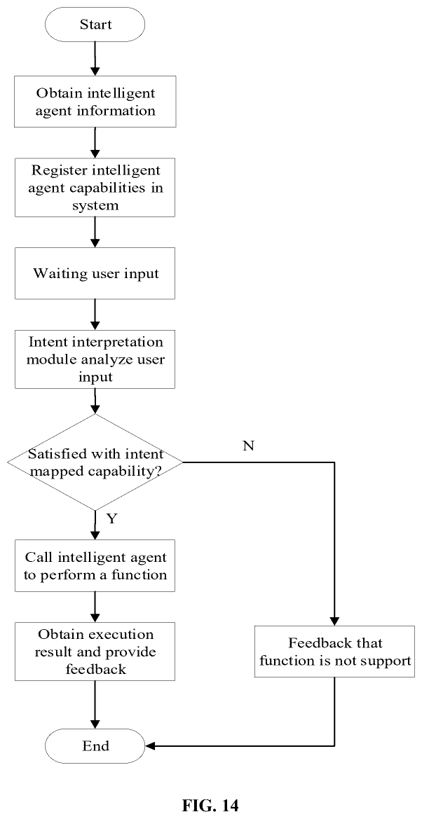

### 6. Schematic of the Intelligent Agent's Range, as Shown in FIG. 13. Specific Process of the Intelligent Agent is Shown in FIG. 14.

First, information of each intelligent agent is obtained, and then the capabilities of each intelligent agent is registered in the system. Then, after waiting for the user to enter the prompt, the intent interpretation model is used to analyze the prompt entered by the user. If the capability of the intent mapping corresponding to the prompt is met in this case, then the corresponding intelligent agent is called to perform the response operation matching the user intent, and the intelligent agent's execution result is obtained and fed back; otherwise, feedback that the capability is not supported will be provided.

Consistent with the present disclosure, combined with the intent interpretation model, a new way for users to interact with the local intelligent agent of the device is defined, which helps users save tedious operation steps and make the operation more convenient for users. The technical solutions of the embodiments of the present disclosure can facilitate the access of new intelligent agents and the removal of existing intelligent agents through cmd mapping relationships, which is convenient and flexible and increases the adaptability of the software.

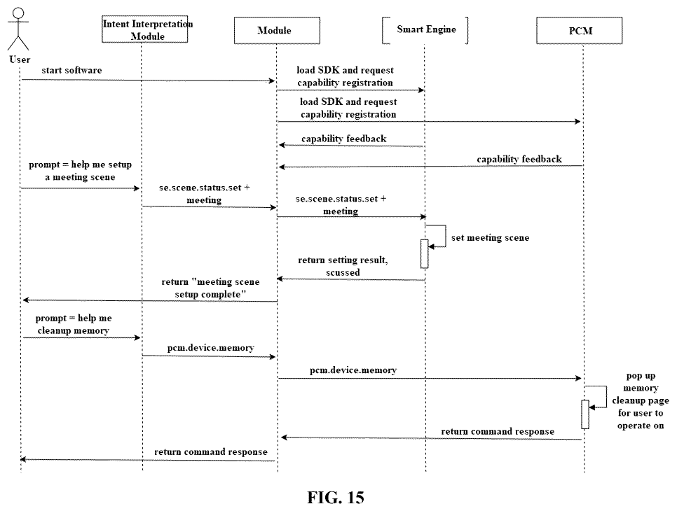

Take the prompt “I'm about to start a meeting” as an example. As shown in FIG. 15 illustrates an interactive flowchart of performing operations based on user intent.

First, the user starts the application software implementing the technical solutions of the present disclosure. The module provided in the technical solutions loads the SDK corresponding to the intelligent agent such as SmartEngine and PCM and requires capability registration. The intelligent agent provides capability feedback to the module.

Then, the user enters the prompt “help me set up the meeting scene” on the interactive interface provided by the application software, and the prompt is given to the intent interpretation module. The intent interpretation module uses the module to set the meeting scene in SmartEngine based on cmd plus param (such as se.scene.status.set+meeting). The setting result such as “scussed” is fed back to the module, and then “the meeting scene setting is completed” is fed back to the application software.

Subsequently, the user enters the prompt of “help me clean up memory” on the interactive interface provided by the application software. After prompting the intent interpretation module, the intent interpretation module uses the module to call PCM based on cmd plus param (such as pcm.device.memory). The PCM pops up a memory cleanup page for the user to operate, and then returns a command response to the module, and then returns a command response to the application software.

In the present disclosure, the embodiments are described in a gradual and progressive manner with the emphasis of each embodiment on an aspect different from other embodiments. The same or similar parts among the various embodiments may refer to each other. Since the disclosed device embodiment corresponds to the disclosed method embodiment, detailed description of the disclosed device is omitted, and reference can be made to the description of the methods for a description of the relevant parts of the device.

As will be appreciated by those of ordinary skill in the art, the embodiments disclosed herein can be implemented by way of electronic hardware, computer software, or a combination of the two. To clearly illustrate the interchangeability between hardware and software, components and steps of respective examples have already been described in a general way in terms of functions in the above description. These functions are to be executed by hardware manner or software manner depending upon the particular application of the technique process and design constraints. Those skilled in the art can use different methods to achieve the described functions with respect to each specific application, but such implementation should not be construed as going beyond the scope of the present disclosure.

The processes of the methods or algorithms described in conjunction with the embodiments of the present disclosure can be implemented with hardware, software modules executed by a processor, or a combination thereof. The software modules may reside in a random-access memory (RAM), an internal memory, a read-only memory (ROM), an electrically programmable ROM, an electrically-erasable programmable ROM, a register, a hard disk, a removable disk drive, CD-ROM, or other types of storage media well known in the technical field.

The foregoing description of the disclosed embodiments will enable a person skilled in the art to realize or use the present disclosure. Various modifications to the embodiments will be apparent to those skilled in the art. The general principles defined herein may be implemented in other embodiments without departing from the spirit or scope of the disclosure. Accordingly, the disclosure will not be limited to the embodiments shown herein, but is to meet the broadest scope consistent with the principles and novel features disclosed herein.

What is claimed is:

1. An interactive processing method comprising:
identifying an acquired target input data to obtain a first user intent;
processing the first user intent based on target reference information to obtain a second user intent; and
performing a response operation matching the second user intent, wherein:
the target reference information corresponding to different target input data is different or the same.

2. The method of claim 1 further comprising at least one of:
obtaining content information and/or attribute information of the target input data, and obtaining the target reference information based on the content information and/or the attribute information, the target reference information being related to or unrelated to the target input data; or
obtaining a comment for the first user intent, and obtaining the corresponding target reference information based on the comment.

3. The method of claim 2, wherein obtaining the target reference information based on the content information and/or the attribute information includes at least one of:
determining an interaction scenario represented by the content information, and obtaining the target reference information matching the interaction scenario;
determining an interactive object in the content information, and obtaining the target reference information based on the interactive object;
determining a data type of the target input data represented by the attribute information, and obtaining the target reference information matching the data type;
determining source information of the target input data represented by the attribute information, and obtaining the target reference information matching the source information;
determining an input position of the target input data represented by the attribute information, and obtaining the target reference information matching the input position; or
determining data size of the target input data represented by the attribute information, and obtaining the target reference information matching the data size.

4. The method of claim 2, wherein obtaining the target reference information based on the content information and/or the attribute information includes at least one of:
obtaining user profile information associated with the content information and/or the attribute information, and using the user profile information as the target reference information;
obtaining long-term memory associated with the content information and/or the attribute information, and using the long-term memory as the target reference information; or
obtaining short-term memory associated with the content information and/or the attribute information, and using the short-term memory as the target reference information.

5. The method of claim 2, wherein obtaining the corresponding target reference information based on the comment includes at least one of:
when the comment includes first feedback information of a target user on the first user intent, using preset reference information matching the first user intent as the target reference information;
when the comment includes second feedback information of the target user on the first user intent, directly using the second feedback information as the target reference information, or generating the target reference information based on the second feedback information; or
when the comment includes supplementary information of the target user on the first user intent, generating the target reference information based on the supplementary information.

6. The method of claim 1, wherein processing the first user intent based on the target reference information to obtain the second user intent includes at least one of:
adding an attribute label corresponding to the target reference information or a prompt word corresponding to the target reference information to the first user intent to obtain the second user intent;
using the target reference information to generate or replace the first user intent to obtain the second user intent; or
processing the first user intent based on a processing strategy corresponding to a type and/or source of the target reference information to obtain the second user intent.

7. The method of claim 6, wherein processing the first user intent based on the processing strategy corresponding to the type and/or source of the target reference information to obtain the second user intent includes at least one of:
when the target reference information is the user profile information of the target user, generating or updating the first user intent based on the user profile information to obtain the second user intent;
when the target reference information only includes the long-term memory, adjusting or editing the first user intent based on the long-term memory to obtain the second user intent;
when the target reference information includes the short-term memory and the long-term memory, updating the first user intent based on the short-term memory, or, when the first user intent cannot be updated using the short-term memory, updating the first user intent using the long-term memory to obtain the second user intent;
when the target reference information is the comment for the first user intent, replacing the first user intent based on the comment or performing intent interpretation processing on the comment and the first user intent again to obtain the second user intent;
when the target reference information comes from a target application, updating the first user intent based on application information of the target application to obtain the second user intent; or
when the target reference information comes from a target space environment, performing a model generation process on the first user intent based on environmental parameters of the target space environment to obtain the second user intent.

8. The method of claim 1, wherein performing the response operation matching the second user intent includes at least one of:
determining a corresponding execution strategy based on the second user intent, and calling a corresponding application tool to perform a target response operation based on the execution strategy;
determining the corresponding execution strategy based on the second user intent, and calling a corresponding intelligent agent to perform the target response operation based on the execution strategy; or
determining the corresponding execution strategy based on the second user intent and the operation state information of an electronic device, and calling the corresponding application tool or intelligent agent to perform the target response operation based on the execution strategy.

9. The method of claim 1 further comprising at least one of:
updating the second user intent based on third feedback information obtained for an execution result of the response operation; or
updating the second user intent based on an input operation acting on an interactive interface of the target intelligent agent.

10. An electronic device comprising:
one or more processors; and
one or more memories coupled to the one or more processors and storing a plurality of computer instructions that, when being executed, cause the one or more processors to perform:
identifying an acquired target input data to obtain a first user intent;
processing the first user intent based on target reference information to obtain a second user intent; and
performing a response operation matching the second user intent, wherein:
the target reference information corresponding to different target input data is different or the same.

11. The electronic device of claim 10, wherein the one or more processors are further configured to perform at least one of:
obtaining content information and/or attribute information of the target input data, and obtaining the target reference information based on the content information and/or the attribute information, the target reference information being related to or unrelated to the target input data; or
obtaining a comment for the first user intent, and obtaining the corresponding target reference information based on the comment.

12. The electronic device of claim 11, wherein the one or more processors are further configured to perform at least one of:
determining an interaction scenario represented by the content information, and obtaining the target reference information matching the interaction scenario;
determining an interactive object in the content information, and obtaining the target reference information based on the interactive object;
determining a data type of the target input data represented by the attribute information, and obtaining the target reference information matching the data type;
determining source information of the target input data represented by the attribute information, and obtaining the target reference information matching the source information;
determining an input position of the target input data represented by the attribute information, and obtaining the target reference information matching the input position; or
determining data size of the target input data represented by the attribute information, and obtaining the target reference information matching the data size.

13. The electronic device of claim 11, wherein the one or more processors are further configured to perform at least one of:
obtaining user profile information associated with the content information and/or the attribute information, and using the user profile information as the target reference information;
obtaining long-term memory associated with the content information and/or the attribute information, and using the long-term memory as the target reference information; or
obtaining short-term memory associated with the content information and/or the attribute information, and using the short-term memory as the target reference information.

14. The electronic device of claim 11, wherein the one or more processors are further configured to perform at least one of:
when the comment includes first feedback information of a target user on the first user intent, using preset reference information matching the first user intent as the target reference information;
when the comment includes second feedback information of the target user on the first user intent, directly using the second feedback information as the target reference information, or generating the target reference information based on the second feedback information; or
when the comment includes supplementary information of the target user on the first user intent, generating the target reference information based on the supplementary information.

15. The electronic device of claim 10, wherein the one or more processors are further configured to perform at least one of:
adding an attribute label corresponding to the target reference information or a prompt word corresponding to the target reference information to the first user intent to obtain the second user intent;
using the target reference information to generate or replace the first user intent to obtain the second user intent; or
processing the first user intent based on a processing strategy corresponding to a type and/or source of the target reference information to obtain the second user intent.

16. The electronic device of claim 15, wherein the one or more processors are further configured to perform at least one of:
when the target reference information is the user profile information of the target user, generating or updating the first user intent based on the user profile information to obtain the second user intent;
when the target reference information only includes the long-term memory, adjusting or editing the first user intent based on the long-term memory to obtain the second user intent;
when the target reference information includes the short-term memory and the long-term memory, updating the first user intent based on the short-term memory, or, when the first user intent cannot be updated using the short-term memory, updating the first user intent using the long-term memory to obtain the second user intent;
when the target reference information is the comment for the first user intent, replacing the first user intent based on the comment or performing intent interpretation processing on the comment and the first user intent again to obtain the second user intent;
when the target reference information comes from a target application, updating the first user intent based on application information of the target application to obtain the second user intent; or
when the target reference information comes from a target space environment, performing a model generation process on the first user intent based on environmental parameters of the target space environment to obtain the second user intent.

17. The electronic device of claim 10, wherein the one or more processors are further configured to perform at least one of:
determining a corresponding execution strategy based on the second user intent, and calling a corresponding application tool to perform a target response operation based on the execution strategy;
determining the corresponding execution strategy based on the second user intent, and calling a corresponding intelligent agent to perform the target response operation based on the execution strategy; or
determining the corresponding execution strategy based on the second user intent and the operation state information of an electronic device, and calling the corresponding application tool or intelligent agent to perform the target response operation based on the execution strategy.

18. The electronic device of claim 10, wherein the one or more processors are further configured to perform at least one of:
updating the second user intent based on third feedback information obtained for an execution result of the response operation; or
updating the second user intent based on an input operation acting on an interactive interface of the target intelligent agent.

19. A non-transitory computer readable storage medium containing a plurality of computer instructions that, when being executed, cause at least one processor to perform:
identifying an acquired target input data to obtain a first user intent;
processing the first user intent based on target reference information to obtain a second user intent; and
performing a response operation matching the second user intent, wherein:
the target reference information corresponding to different target input data is different or the same.

20. The storage medium of claim 10, wherein the at least one processor is further configured to perform at least one of:
obtaining content information and/or attribute information of the target input data, and obtaining the target reference information based on the content information and/or the attribute information, the target reference information being related to or unrelated to the target input data; or
obtaining a comment for the first user intent, and obtaining the corresponding target reference information based on the comment.
